(19) United States
(12) Patent Application Publication
(10) Pub. No.: US 2006/0179308 A1
(43) Pub. Date: Aug. 10, 2006

(54) System and method for providing a secure boot architecture

(76) Inventors: Andrew Morgan, Los Gatos, CA (US); Christian Ludloff, San Jose, CA (US); Guillermo Rozas, Los Gatos, CA (US)

Correspondence Address: WAGNER, MURABITO & HAO LLP, Third Floor, Two North Market Street, San Jose, CA, 95113, US

(21) Appl. No.: 11/053,081

(22) Filed: Feb. 7, 2005

(51) Int. Cl. H04L 9/00

(52) U.S. Cl. 713/168

(57) ABSTRACT

A system and method for providing a secure boot architecture, in accordance with one embodiment of the present invention, includes a processor having an atomic state machine and a physically protected storage area. The atomic state machine stores a state of the processor in a state save map upon a boot-mode event. The atomic state machine also authenticates an object of a Pre-BIOS Boot Vector Region (PBBVR) in response to the boot-mode event. The PBBVR may be stored in the physically protected storage area. The atomic state machine loads the PBBVR from the physically protected storage area into an overlay memory if the PBBVR is successfully authenticated. The processor executes the PBBVR from the overlay memory if the PBBVR is successfully authenticated. The atomic state machine may also receive a candidate PBBVR upgrade image, authenticate the candidate PBBVR upgrade image, and replace the current PBBVR with a new PBBVR contained in the candidate PBBVR upgrade image if the new PBBVR in the candidate PBBVR upgrade image is authenticated.

### BACKGROUND OF THE INVENTION

The execution of blocks of instructions by a processor generally performs some operation. To a great extent all instructions sequences are valid from the perspective of the processor. The processor has no meaningful notion of a complete and/or valid program or function. Thus, if a block of instructions can be presented to a processor, they will generally be executed. Accordingly, instruction sequences containing so-called illegal instructions may reliably cause the processor to execute, fault or halt.

Hence, it is desirable to restrict the execution of code by a processor. One way to restrict execution is by authentication of the sequence of instructions. In the conventional art, one or more blocks of code may be authenticated to provide a secure computing environment. The authentication process establishes a block of code as a trusted sequence of instructions. However, the conventional authentication process relies upon the assumption that the given block of code from which another block of code's authentication depends upon can be trusted. The authentication process may be utilized to establish a chain of trust. However the process of chaining the authentication of multiple code blocks together still relies upon the assumption that a root block of code is trusted. Accordingly, a conventional secure computing architecture remains vulnerable as a result of the fact that the root block of code may not be trusted.

### SUMMARY OF THE INVENTION

Accordingly, embodiments of the present invention are directed toward a system having a secure boot architecture. In the secure boot architecture, a target instruction for a processor may be authenticated in a boot-mode such that all instructions executed on the processor can root their trust back to the processor implementation. Embodiments of the present invention may also provide a processor enforced boot-mode upgrade mechanism.

In one embodiment, a processor having a secure boot architecture includes an atomic state machine coupled to a physically protected storage area. The physically protected storage area stores a boot-mode object. The atomic state machine authenticates the boot-mode object before execution by a processor of a first target instruction. The atomic state machine may also receive a candidate boot-mode upgrade image, authenticate the candidate boot-mode upgrade image, and replace the current boot-mode object with a new boot-mode object contained in the candidate boot-mode upgrade image if the candidate boot-mode upgrade in the candidate boot-mode upgrade image is authenticated.

In another embodiment, a method for providing a secure boot architecture includes receiving a boot-mode event, authenticating a boot-mode object, and executing a first target instruction if the boot-mode object is authenticated. The method may further include receiving a candidate boot-mode upgrade image, authenticating the candidate boot-mode upgrade image and replacing the current boot-mode code with the new boot-mode code in the candidate boot-mode upgrade image if the candidate boot-mode upgrade image is authenticated.

In yet another embodiment, a system for providing a secure boot architecture includes an atomic state machine coupled to a physically protected storage area. The atomic state machine stores a state of a processor in a state save map upon the occurrence of a boot-mode event. The atomic state machine also authenticates an object of a Pre-BIOS Boot Vector Region (PBBVR) in response the boot-mode event. The PBBVR may be stored in the physically protected storage area. The atomic state machine loads the PBBVR from the physically protected storage area into an overlay memory, if the PBBVR is successfully authenticated. The processor may then execute the PBBVR from the overlay memory, if the PBBVR is successfully authenticated.

### BRIEF DESCRIPTION OF THE DRAWINGS

Embodiments of the present invention are illustrated by way of example and not by way of limitation, in the figures of the accompanying drawings and in which like reference numerals refer to similar elements and in which:

FIG. 1 shows a block diagram of a system for establishing a secure boot architecture, in accordance with one embodiment of the present invention.

FIGS. 2A and 2B show a flow diagram of a method for establishing a secure boot architecture, in accordance with one embodiment of the present invention.

FIG. 3 shows a format of a Pre-BIOS Boot Vector Region (PBBVR)) object, in accordance with one embodiment of the present invention.

FIG. 4 shows a format of a physical memory and an overlay memory, in accordance with one embodiment of the present invention.

FIG. 5 shows a flow diagram of a method for controlling the upgrade of the boot-mode code, in accordance with one embodiment of the present invention.

FIG. 6 shows a format of a boot-mode upgrade object, in accordance with one embodiment of the present invention.

### DETAILED DESCRIPTION OF THE INVENTION

Reference will now be made in detail to the embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the scope of the invention as defined by the appended claims. Furthermore, in the following detailed description of the present invention, numerous specific details are set forth in order to provide a thorough understanding of the present invention. However, it is understood that the present invention may be practiced without these specific details. In other instances, well-known methods, procedures, components, and circuits have not been described in detail as not to unnecessarily obscure aspects of the present invention.

Embodiments of the present invention provide a secure boot architecture. A boot-mode, of the secure boot architecture, authenticates the target instruction for a processor such that all instructions executed on the processor can root their trust back to the processor implementation. Therefore, authentication is established before the basic input output system (BIOS) boot block. Embodiments of the present invention may also provide a mechanism by which authenticated boot-mode code may be upgraded without loss of trust.

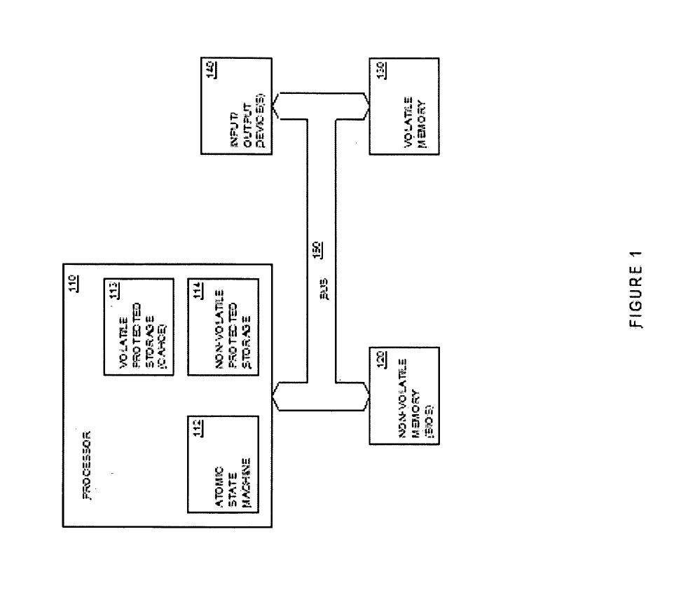

Referring to FIG. 1, a block diagram of a system for establishing a secure boot architecture, in accordance with one embodiment of the present invention, is shown. As depicted in FIG. 1, the secure boot architecture system includes a processor 110, one or more physical memory units 120, 130, one or more input/output devices 140 and the like. It is appreciated that the processor 110 referred to herein may be a general purpose processor, a dedicated controller or the like. The one or more physical memory units 120, 130 and the one or more input/output devices 140 may be communicatively coupled to the processor 110. In one implementation, the one or more physical memory units 120, 130 and the one or more input/output devices 140 may be communicatively coupled to the processor 110 by one or more buses 150.

The processor 110 may include an atomic state machine 112, a volatile physically protected storage area (e.g., cache) 113 and a non-volatile physically protected storage area 114. The atomic state machine 112 may implement a boot-mode and may optionally implement a boot-mode upgrade mechanism. The non-volatile physically protected storage area 114 may contain boot-mode code. In one implementation, the volatile 113 and non-volatile 114 physically protected storage areas may be integral parts of the processor 110 (e.g., fabricated on the processor die). In another implementation, the volatile 113 and non-volatile 114 physically protected storage areas may be separate from the processor 110. In one implementation, the non-volatile physically protected storage area 114 containing boot-mode code may be writeable non-volatile memory (e.g., flash memory or the like).

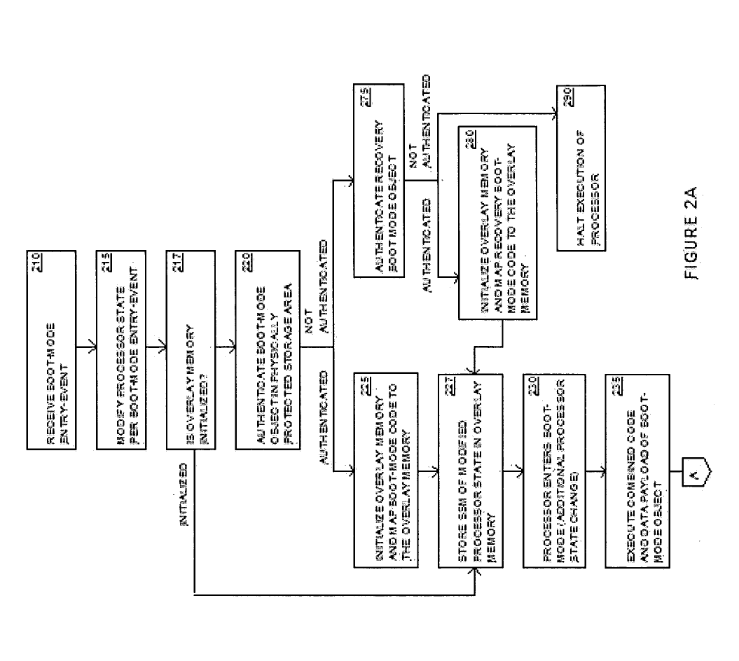

The system for establishing a secure boot architecture of FIG. 1, will be further described herein in conjunction with FIGS. 2A and 2B. As depicted in FIGS. 2A and 2B, a flow diagram of a method for establishing a secure boot architecture, in accordance with one embodiment of the present invention, is shown.

Establishing a secure boot architecture may be initiated by receipt of a boot-mode entry-event, at 210, by the processor 110. The boot-mode entry-events may include events that have implications for the trustability of post-event code execution and/or benefit from the authentication gate provided by the boot-mode. The boot-mode entry-event may include one or more events such as a reset, a partial reset, one or more interrupts from an interrupt controller, one or more interrupts from a shutdown state (e.g., for multiprocessor systems). In one implementation, the boot-mode entry-events in a legacy system (e.g., x86) may include:

| ENTRY_ID | BOOT-MODE ENTRY-EVENT |
|---|---|
| 0 | RESET |
| 1 | INIT |
| 2 | APIC_IPI_INIT |
| 3 | APIC_IPI_INIT_W_VECTOR |
| 4 | APIC_INI_SMI |
| 5 | APIC_INI_NMI |
| 6 | RESET_FROM_SHUTDOWN |
| 7 | INIT_FROM_SHUTDOWN |
| 8 | SMI_FROM_SHUTDOWN |
| 9 | NMI_FROM_SHUTDOWN |

The boot-mode entry-event may be a non-maskable interrupt. Once in boot-mode, the processor will defer delivery of non-maskable interrupts, including the system management interrupt (SMI), until boot-mode is exited.

At 215, receipt of a boot-mode entry-event may cause the processor 110 to modify its state. In one implementation, for the RESET boot-mode entry-event, the code segment register (e.g., cs_base), instruction pointer register (e.g., eip) and system management base register (e.g., sm_base) of the processor 110 may be modified to the following values:

cs_base=0xffff0000
eip=0x0000fff0

sm-base=0x00030000

It is appreciated that the code segment register and the instruction pointer register point to the BIOS boot block. In one implementation, entering boot-mode cause the current state (e.g., legacy reset) to be written to the state save map at the end of an extended overlay memory.

At optional process 217, the atomic state machine 112 may determine if the overlay memory is initialized. It is appreciated that reinitialization of the overlay memory may be avoided for one or more boot-mode entry-events. Accordingly, if the overlay memory is currently initialized the method for establishing a secure boot architecture may proceed at process 227. If the overlay memory is not currently initialized the method may proceed at process 220.

At 220, the atomic state machine 112 authenticates the boot-mode code stored in the non-volatile physically protected storage area 114. The authentication of the boot-mode code may be implementation specific. In one implementation, authentication of the boot-mode code may be accomplished utilizing a simple checksum algorithm. In another implementation, authentication of the boot-mode code may be accomplished utilizing a complicated digital signature verification process. The sophistication of the authentication process may be a function of the physical security of the non-volatile physically protected storage area 114 used to hold the boot-mode code. Accordingly, the more tightly coupled the physically protected storage area 114 is to the processor 110 the lesser degree of authentication may be needed.

At 225, the overlay memory may be initialized and the boot-mode code may be mapped into the overlay memory. The overlay memory may be constructed by combining the authenticated boot-mode code and reserved boot-mode data area. In a modified x86 implementation, the boot-mode code is a Pre-BIOS Boot Vector Region (PBBVR) object. In such an implementation, the overlay memory is mapped to a portion of the physical address space obscuring a portion of the regular physical memory (e.g., RAM 130) while executing in boot-mode. In one implementation this overlay memory is maintained as processor internal memory 113 (e.g., a processor internal cache array). In one implementation, this overlay memory is a processor protected fraction of main memory 130.

The modified state of the processor 110 may be stored in a state save map (SSM), at 227. In a modified x86 implementation, entering boot-mode as a result of the RESET event, causes the current state (e.g., legacy reset) to be written to the state save map at the end of the extended overlay memory.

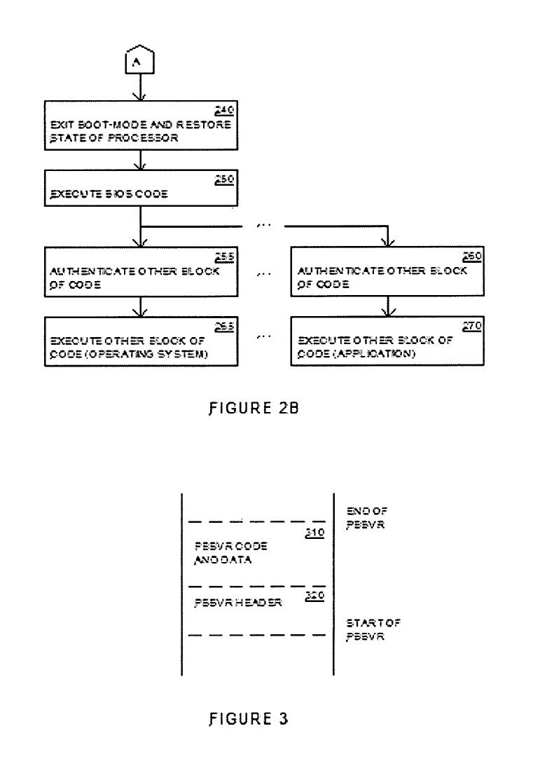

Referring now to FIG. 3, a format of a Pre-BIOS Boot Vector Region (PBBVR)) object, in accordance with one embodiment of the present invention, is shown. As depicted in FIG. 3, the PBBVR may contain a header 310 and a combined code and data payload 320. The length of the PBBVR may be an integer number of contiguous pages. The header 310 may have a defined layout and includes PBBVR configuration and authentication data that covers the entire PBBVR object and its run-time environment. The combined code and data payload 320 may contain any desired code and data for execution in boot-mode.

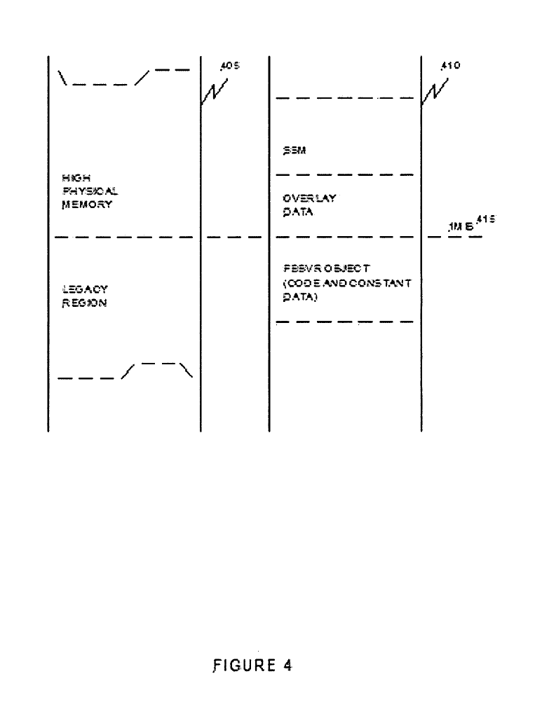

Referring now to FIG. 4, a format of a physical memory 405 and an overlay memory 410, in accordance with one embodiment of the present invention, is shown. As depicted in FIG. 4, the overlay memory 410 may be mapped to a predetermined physical memory 405 location. The overlay memory 410 may be mapped such that it ends on a predetermined boundary (e.g., 1 MiB) 415. In a modified x86 implementation, the overlay memory 410 is mapped to the physical address surrounding 00x00100000 (e.g., 1 MB). In the context of such an implementation, it is appreciated that the overlay appears to be regular volatile memory (e.g., RAM 130) closer to the core than the APIC memory, but it is not visible to direct memory access (DMA) from input/output devices 140. It is also appreciated that it is not visible to code executing outside boot-mode.

Referring again to FIGS. 1, 2A and 2B, once the current state of the processor 110 is stored in the state save map and the boot-mode code has been authenticated, the state of the processor 100 may be changed by the atomic state machine 112 to initiate run time execution of the boot-mode code from the overlay memory, at 230. In a modified x86 implementation, boot-mode is entered with a register state most like that of System Management Mode (SMM), e.g., a 16-bit code segment, and flat data segments. However, the instruction pointer is set as follows:

cs_base=0x000f0000
eip=0x0000fff0
   Accordingly, code execution (e.g., following a RESET event) will begin at a location different than where the BIOS boot vector is located.

The reason for processor entry into boot-mode, may be captured in some machine state register. In a modified x86 implementation, one or more parameters of the event that causes entry into the boot-mode may also be captured in a boot-mode machine specific register (MSR):
MSR_TMx86_BOOT_MODE_ENTRY_STATE=0x80868077

The boot-mode specific MSR performs as follows:

RDMSR [MSR_TMx86_BOOT_MODE_ENTRY_STATE] :

If (NOT executing_in_boot_mode) {

#GP(0) ;

} else {

Fill eax and edx as per the following ‘C’ union ;
Typedef union tsb_msr_info_u {

struct {

uint32 eax_lo ;
uint32 edx_hi ;

} flat ;
struct {

unsigned entry _event : 5 ;
unsigned _rsvl : 6;
unsigned data_preserved : 1 ;
unsigned data_page_extension_count : 8 ;
unsigned _rsv2 : 12 ;
unsigned _rsv3 : 32 ;

} bits ;

} tsb_msr_info_t ;

}

The value tsb_msr_info_t.bits.entry_event bitfield contains the entry_id as described above. Accordingly, a code indicative of the event that caused the boot-mode entry is returned. The tsb_msr_info_t.bits.data_page_extension_count contains the number of additional 4 KiB pages provided in boot-mode. The extended overlay size returned is the actually additional memory allocated by the processor 110, not the pages requested in the header of the PBBVR. The tsb_msr_info_t.bits.data_preserved bit indicates whether the entry into boot-mode preserved the contents of the overlay memory from a previous invocation (a value of ‘0’ indicates that the boot-mode overlay has been freshly instantiated, and a value of ‘1’ indicates that the overlay contains data preserved since the last exit from boot-mode).

In one implementation, after having authenticated the PBBVR, the processor extends the overlay to include one or more extra data pages (e.g., a non-zero multiple of 4 KiB). The size of the overlay memory may be defined in the header of the PBBVR. In one implementation, the PBBVR may be copied to an overlay memory which is up to 192 KiB. The extended overlay memory may be initialized to 0xff.

It is appreciated by those skilled in the art how code execution in SMM can enter protected mode. Protected mode may enable paging, exception and interrupt handling and the like, without leaving SMM. It is furthermore appreciated, that such protected mode features are shared by boot-mode. Accordingly, operations that can be performed from boot-mode range from: the trivial, such as simply executing the RSM instruction; to imitating a legacy x86 (e.g., with no boot-mode support), to the extensive, such as pre-BIOS execution of code to fully validate the BIOS with peripheral based recovery of the BIOS in the event of BIOS corruption; or to implement a non-legacy boot sequence that could initialize an SMM handler or operating system hidden in a locked T-segment. Thus, through modification of the boot-mode SSM prior to the PBBVR code executing the RSM instruction, arbitrary machine states and modes can be realized.

At 235, the combined code and data payload of the boot-mode object may be executed from the overlay memory. In one implementation, the code may authenticate the BIOS boot block. At 240, the boot-mode may be exited. In one implementation, the PBBVR code may exit by executing a resume from system management mode (RSM) instruction. It is appreciated that, following a RESET boot-mode entry-event, the cs_base, eip and sm_base values stored in the boot-mode state save map (SSM) are those of the legacy reset vector. It is further appreciated that if the code present at the overlay boot-mode entry vector (e.g., 0xf000:fff0) contain a single RSM instruction, then the modified processor will immediately exit boot-mode and initiate a legacy boot, chaining to the BIOS.

If the PBBVR is authenticated, the BIOS code may be executed at 250. At 265-270, operation of the processor may continue with execution of one or more other blocks of code. One or more of the other blocks of code may be authenticated, at 255-260, against the authenticated BIOS code which roots its authentication back to the PBBVR boot-mode code.

If the PBBVR is not authenticated, operation of the processor may be halted at 290. Optionally, prior to halting operation of the processor, a recovery version of the PBBVR may be run-time authenticated by the processor, at 275. At 280, the recovery version of the PBBVR may be loaded from the physically protected storage area 114 into the predetermined overlay memory, if the recovery version of the PBBVR is successfully authenticated. If the recovery version of the PBBVR is authenticated, run-time execution of the processor may continue with process 230 as described above. If the recovery version of the PBBVR is not authenticated, the operation of the processor may be halted at 290. Thus, the processor may refuse to execute further if neither the primary boot-mode code nor recovery boot-mode code are authenticated.

Accordingly, embodiments of the present invention provide a secure boot architecture. The boot-mode of the secure boot architecture advantageously authenticates the target instruction for a processor such that all instructions executed on the processor can root their trust back to the processor implementation. Hence, authentication is established before the basic input output system (BIOS) boot block is executed.

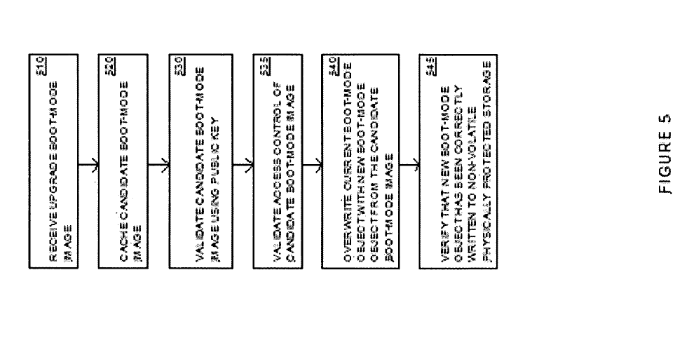

The processor implementation of the above described boot-mode may be complimented by an additional processor enforced upgrade mechanism. Referring now to FIG. 5, a flow diagram of a method for controlling the upgrade of the boot-mode code, in accordance with one embodiment of the present invention, is shown. The method for controlling the upgrade of boot-mode code will be described with reference to the system of FIG. 1.

A system having a secure boot architecture may be upgraded if at least one pre-existing correctly formatted and authenticated boot-mode object (e.g., PBBVR) is present in the physically protected storage area 114. The boot-mode code upgrade mechanism may utilizes a private/public key authentication algorithm. The process for upgrading the boot-mode code in a system begins with receipt of a boot-mode upgrade image, at 510. In one implementation, a platform manufacturer generates the signed PBBVR upgrade object, which is passed to the system via an input/output device 140.

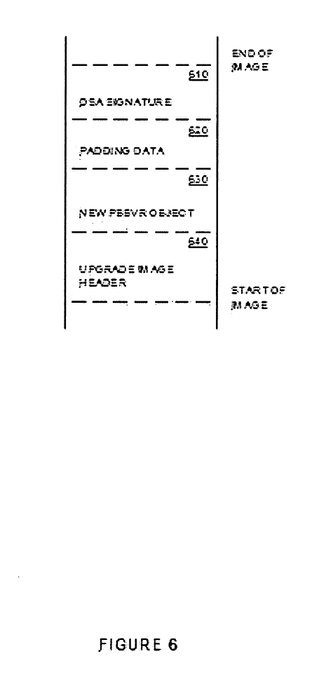

Referring now to FIG. 6, a format of a boot-mode upgrade object (e.g., signed PBBVR upgrade image), in accordance with one embodiment of the present invention, is shown. As depicted in FIG. 6, the object includes a digital signature (e.g., DSA signature) 610, padding data 620, a new boot-mode code (e.g., new PBBVR) object 630 and an upgrade image header 640. The upgrade image header 640 includes upgrade image size and version-matching information. The new PBBVR 630 contains authentication information to be used by the upgraded system. The new PBBVR 630 is not used as part of the upgrade authentication for the present upgrade. It is the combination of the running PBBVR, as it exists in the non-volatile physically protected storage area 114, the contents of the upgrade image header 640 and digital signature 610 that is utilized to authenticate the boot-mode upgrade image.

At 520, the received boot-mode upgrade image (e.g., candidate upgrade image) may be cached in the volatile physically protected storage area 113. In a modified x86 implementation, upon receipt of the boot-mode upgrade image, x86 code executing in any privileged mode (e.g., boot-mode, system management mode, real mode, protected mode or the like) initializes the values of the ECX, EAX and EDX registers as follows:
ECX=MSR_TMx86_PBBVR_UPGRADE=0x80868008
EAX=linear address of base of signed PBBVR image
EDX=number of DWORDS in signed PBBVR image
   Given that the legacy code has arranged for the signed PBBVR upgrade image to be based at the value held in EAX and that it is EDX DWORDS in length, the legacy code executes a WRMSR instruction. The WRMSR machine specific operation causes the current processor to cache a copy of the candidate upgrade image. The cached copy of the candidate upgrade image should be protected from direct memory access and snoop requests from peer processors.

At 530, the public key in the header of the current boot-mode object is used to validate the digital signature 610 in the upgrade image header of the candidate boot-mode upgrade image. In one implementation, the WRMSR instruction re-reads the header of the current PBBVR from the non-volatile physically protected storage area 114 to extract a public DSA key. The WRMSR instruction also validates the DSA signature of the received candidate PBBVR upgrade image with respect to this public DSA key. If the candidate upgrade image fails this authentication, completion of the WRMSR machine specific operation may generate a status report via RDMSR (e.g., 0x80868000).

At 535, additional validation of the candidate boot-mode upgrade image may be performed. In one implementation, the WRMSR instruction may also validate the candidate PBBVR upgrade image against access control information, such as matching ‘current’ fields to permitted ranges specified in the incoming candidate PBBVR upgrade image. If the candidate upgrade image fails this access control test, completion of the WRMSR machine specific operation may generate a status report via RDMSR (e.g., 0x80868000).

If the authentication and access control checks succeed, the processor 110 may overwrite the current boot-mode object in the physically protected storage area 114, at 540. At 545, the new boot-mode object written to the physically protected storage area 114 may then be verified. In one implementation, if the current primary PBBVR in the physically protected storage area 114 can be verified to be valid, the processor 110 may first overwrite the current recovery PBBVR. The processor may then verify that the new recovery PBBVR was written to the physically protected storage area 114 correctly. The processor may then repeat the procedure to write the upgrade PBBVR as the new primary PBBVR in the physically protected storage area 114.

In an alternative implementation, if the primary PBBVR in the physically protected storage area 114 is found to be invalid, the processor may overwrite the invalid primary PBBVR with the new PBBVR and verify that the new primary PBBVR was correctly written to the physically protected storage area 114. The processor may then overwrite the recovery PBBVR with the new PBBVR and verify that the new recovery PBBVR was also correctly written to the physically protected storage area 114. Hence, there will exist at least one uncorrupted PBBVR image in the physically protected storage area 114, even in the face of events such as power failure, thermal event and the like that may cause corruption of the PBBVR upgrade process.

Accordingly, embodiments of the present invention provide a mechanism by which authenticated boot-mode code may be upgraded. It is appreciated that the boot-mode code may advantageously be upgraded in a running system without loss of trust.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A processor having a secure boot architecture comprising:
a physically protected storage area for storing a boot-mode object; and
an atomic state machine, coupled to said physically protected storage area, for authenticating said boot-mode object before execution of a first target instruction.

2. The processor of claim 1, wherein said boot-mode object comprises a header portion and a combined code and data payload portion.

3. The processor of claim 2, wherein said header portion comprises a defined memory size.

4. The processor of claim 3, wherein said header comprises configuration and authentication data.

5. The processor of claim 1, wherein said atomic state machine is operable to:
receive a candidate boot-mode upgrade image;
authenticate said candidate boot-mode upgrade image; and
replace said boot-mode object with a new boot-mode object in said candidate boot-mode upgrade image if said candidate boot-mode upgrade image is authenticated.

6. A method for providing a secure boot architecture for a computer system having a processor comprising:
receiving a boot-mode event;
authenticating a boot-mode object; and
executing a first target instruction if said boot-mode object is authenticated.

7. The method according to claim 6, further comprising:
storing an initialization state;
executing a first instruction in said boot-mode object after storing said initialization state; and
restoring said initialization state after executing said first instruction.

8. The method according to claim 6, further comprising:
authenticating a recovery boot-mode object if said boot-mode object is not authenticated;
executing said first instruction if said recovery boot-mode object is authenticated; and
halting execution if said recovery boot-mode object is not authenticated.

9. The method according to claim 6, wherein said authenticating said boot-mode object comprises a digital signature verification process.

10. The method according to claim 6, wherein said authenticating said boot-mode object comprises a checksum verification process.

11. The method according to claim 6, wherein said boot-mode event comprises a non-maskable interrupt.

12. The method according to claim 6, wherein said boot-mode object comprises a header having a defined layout.

13. The method according to claim 12, wherein said header comprises configuration and authentication data.

14. The method according to claim 6, further comprising storing a parameter of said boot-mode event in a boot-mode specific machine state register.

15. The method according to claim 6, further comprising:
receiving a candidate boot-mode upgrade image;
authenticating said candidate boot-mode upgrade image; and
replacing said boot-mode object with a new boot-mode object of said candidate boot-mode upgrade image if said candidate boot-mode upgrade image is authenticated.

16. The method according to claim 15, wherein authenticating said candidate boot-mode upgrade image comprises validating a digital signature of said candidate boot-mode upgrade image with respect to a public key of said boot-mode code.

17. A system for providing a secure boot architecture comprising:
a physically protected storage area for storing a primary boot-mode object;
an atomic state machine for;
storing a state of a processor in a state save map upon receipt of a boot-mode event;
authenticating an object of said primary primary boot-mode object upon receipt of said boot-mode event; and
loading said primary primary boot-mode object from said physically protected storage area into an overlay memory if said primary PBBVR is successfully authenticated; and
said processor for executing said primary primary boot-mode object from said overlay memory if said primary primary boot-mode object is successfully authenticated.

18. The system according to claim 17, wherein said primary boot-mode object comprises a primary Pre-BIOS Boot Vector Region (PBBVR).

19. The system according to claim 18, said atomic state machine for further restoring said state of said processor from said state save map after executing said primary PBBVR.

20. The system according to claim 17, wherein:
said physically protected storage area is for further storing a recovery primary boot-mode object;
said atomic state machine is for further:
authenticating an object of said recovery boot-mode object if said primary boot-mode object is not successfully authenticated;
loading said recovery boot-mode object from said physically protected storage area into said overlay memory if said recovery boot-mode object is successfully authenticated; and
restoring said state of said processor from said state save map after executing said recovery boot-mode object; and
halting execution by said processor if said recover boot-mode object is not successfully authenticated; and
said processor is for executing said recovery boot-mode object from said overlay memory if said recovery boot-mode object is successfully authenticated.

21. The system according to claim 20, wherein said recovery boot-mode object comprises a recovery PBBVR.

22. The system according to claim 17, wherein restoring said state of said processor causes execution by said processor to jump to a BIOS boot block.

23. The system according to claim 19, wherein said primary PBBVR comprises a header and a combined code and data payload.

24. The system according to claim 23, wherein said primary PBBVR comprises an integer number of contiguous pages.

25. The system according to claim 23, wherein said primary PBBVR comprises processor configuration and authentication data.

26. The system according to claim 17, wherein said overlay memory is mapped to a predetermined physical memory location.

27. The system according to claim 17, wherein said overlay memory appears to be regular memory.

28. The system according to claim 17, wherein said overlay memory is not visible to direct memory access by an input/output device.

29. The system according to claim 17, wherein said overlay memory is not visible to code executing outside boot-mode.

30. The system according to claim 17, wherein said state save map is stored at the end of said overlay memory.

31. The system according to claim 17, further comprising a boot-mode specific machine state register for capturing a parameter of said boot-mode event.

32. The system according to claim 18, said atomic state machine for further:
receiving a candidate PBBVR upgrade image;
authenticating said candidate PBBVR upgrade image; and
replacing said primary PBBVR and said recovery PBBVR with a new PBBVR of said candidate PBBVR upgrade image if said candidate PBBVR upgrade image is authenticated.

33. The system according to claim 18, wherein authenticating said candidate PBBVR upgrade image comprises validating a digital signature of said candidate boot-mode upgrade image with respect to a public key of said primary PBBVR or said recovery PBBVR.
